(19) United States
(12) Patent Application Publication
(10) Pub. No.: US 2013/0177743 A1
(43) Pub. Date: Jul. 11, 2013

(54) GRAIN ORIENTED ELECTRICAL STEEL SHEET

(71) Applicants: Makoto Watanabe, Tokyo (JP); Seiji Okabe, Tokyo (JP); Toshito Takamiya, Tokyo (JP)

(72) Inventors: Makoto Watanabe, Tokyo (JP); Seiji Okabe, Tokyo (JP); Toshito Takamiya, Tokyo (JP)

(73) Assignee: JFE STEEL CORPORATION, Tokyo (JP)

(21) Appl. No.: 13/824,660

(22) PCT Filed: Sep. 27, 2011
(86) PCT No.: PCT/JP2011/005433

§ 371 Date: Mar. 18, 2013

(30) Foreign Application Priority Data
Sep. 28, 2010 (JP) 2010-217370

(51) Int. Cl. H01F 1/18

(52) U.S. Cl. CPC H01F 1/18
USPC 428/167

(57) ABSTRACT

A grain oriented electrical steel sheet keeps iron loss at a low level when assembled as an actual transformer and has excellent iron loss properties as an actual transformer, in which a film thickness a₁ (μm) of insulating coating at the floors of linear grooves, a film thickness a₂ (μm) of the insulating coating on a surface of the steel sheet at portions other than the linear grooves, and a depth a₃ (μm) of the linear grooves are controlled to satisfy formulas (1) and (2):

0.3 μm≦a₂≦3.5 μm (1), and

a₂+a₃−a₁≦15 μm (2).

### RELATED APPLICATIONS

This application is a §371 of International Application No. PCT/JP2011/005433, with an international filing date of Sep. 27, 2011 (WO 2012/042854 A1, published Apr. 5, 2012), which is based on Japanese Patent Application No. 2010-217370, filed Sep. 28, 2010, the subject matter of which is incorporated herein by reference.

### TECHNICAL FIELD

This disclosure relates to grain oriented electrical steel sheets for use in iron core materials of transformers or the like.

### BACKGROUND

Grain oriented electrical steel sheets, which are mainly used as iron cores of transformers, are required to have excellent magnetic properties, in particular, less iron loss. In this regard, it is important to highly accord secondary recrystallized grains of a steel sheet with (110)[001] orientation, i.e., what is called “Goss orientation,” and reduce impurities in a product steel sheet. However, there are limits on controlling crystal grain orientation and reducing impurities in view of production cost and so on. Accordingly, there have been developed techniques for iron loss reduction, which is to apply non-uniform strain to a surface of a steel sheet physically to subdivide magnetic domain width, i.e., magnetic domain refining techniques.

For example, JP 57-002252 B proposes a technique of irradiating a steel sheet after final annealing with a laser to introduce high-dislocation density regions into a surface layer of the steel sheet, thereby narrowing magnetic domain widths and reducing iron loss of the steel sheet.

In addition, JP 62-053579 B proposes a technique of refining magnetic domains by forming linear grooves having a depth of more than 5 μm on the steel substrate portion of a steel sheet after being subjected to final annealing at a load of 882 MPa to 2156 MPa (90 kgf/mm² to 220 kgf/mm²), and then subjecting the steel sheet to heat treatment at a temperature of 750° C. or higher.

Moreover, JP 3-069968 B proposes a technique of introducing linear notches (grooves) of 30 μm to 300 μm wide and 10 μm to 70 μm deep, in a direction substantially perpendicular to the rolling direction of a steel sheet at intervals of 1 mm or more in the rolling direction.

With the development of the magnetic domain refining techniques as above, it is now becoming possible to obtain grain oriented electrical steel sheets having good iron loss properties.

Usually, however, when a steel sheet having grooves formed on a surface thereof is sheared into iron core materials to be assembled into a transformer or the like, each successive iron core material is stacked with a sliding motion on top of the previously stacked iron core material. Accordingly, a problem that can arise is that the sliding motion of an iron core material is interrupted by groove portions, which results in lower working efficiency.

Moreover, in addition to the problem of working efficiency, another problem that can arise is that the interruption by groove portions causes local stress to be placed on the steel sheet, introduces strain into the steel sheet, and thereby deteriorates the magnetic properties thereof.

It could therefore be helpful to provide such a grain oriented electrical steel sheet having grooves for magnetic domain refinement formed thereon capable of keeping iron loss at a low level when assembled as an actual transformer and has excellent iron loss properties as an actual transformer.

### SUMMARY

We thus provide:
[1] A grain oriented electrical steel sheet comprising: linear grooves provided on a surface of the steel sheet; and insulating coating applied to the surface, wherein a film thickness a₁ (μm) of the insulating coating at the floors of the linear grooves, a film thickness a₂ (μm) of the insulating coating on the surface of the steel sheet at portions other than the linear grooves, and a depth a₃ (μm) of the linear grooves satisfy Formulas (1) and (2):

0.3 μm≦a₂≦3.5 μm (1), and

a₂+a₃−a₁≦15 μm (2).
[2] The grain oriented electrical steel sheet according to [1] above, wherein tension applied to the steel sheet by the insulating coating is 8 MPa or less.
[3] The grain oriented electrical steel sheet according [1] or [2] above, wherein the insulating coating is formed by using a phosphate-silica-based coating treatment liquid.

Our steel sheets and methods may provide a grain oriented electrical steel sheet that is capable of effectively reducing iron loss when assembled as an actual transformer and that has excellent iron loss properties as an actual transformer.

### BRIEF DESCRIPTION OF THE DRAWINGS

Our steel sheets and methods will be further described below with reference to the accompanying drawings, wherein:

FIG. 1 is a schematic diagram illustrating a coating film thickness a₁ (μm) at the floor of a linear groove, a coating film thickness a₂ (μm) at portions other than the linear groove, and a linear groove depth a₃ (μm); and

FIG. 2 illustrates how to measure and calculate the tension applied by insulating coating to the steel sheet.

### REFERENCE SIGNS LIST

1 Portions other than linear groove
2 Linear groove

### DETAILED DESCRIPTION

Our steel sheets and methods will be specifically described below.

Usually, when linear grooves (hereinafter, referred to simply as “grooves”) are formed on a surface of a steel sheet, the following processes are carried out to ensure the insulation property of a steel sheet: grooves are first formed on the surface of the steel sheet, then a forsterite film is formed on the surface and, thereafter, a film for insulation (hereinafter, referred to “insulating coating” or simply as “coating”) is applied to the surface. During decarburization in manufacturing a grain oriented electrical steel sheet, an internal oxidation layer, which is mainly composed of SiO₂, is formed on a surface of the steel sheet, and then an annealing separator containing MgO is applied on the surface. Subsequently, the forsterite film is formed during final annealing at a high temperature for a long period of time such that the internal oxidation layer is allowed to react with MgO.

On the other hand, the insulating coating to be applied by top coating on the forsterite film may be obtained by application of a coating liquid and subsequent baking When these films are quenched to normal temperature after being formed at high temperature for application, those films having a small contraction rate serve to apply tensile stress to the steel sheet as a function of their differences in thermal expansion coefficient from the steel sheet.

An increase in the film thickness of the insulating coating leads to an increase in the tension applied to the steel sheet, which is more effective in improving iron loss properties. On the other hand, there has been a tendency that the stacking factor (the proportion of the steel substrate) decreases at the time of assembling an actual transformer and the transformer iron loss (building factor) decreases relative to the material iron loss. Accordingly, conventional methods only control the film thickness (coating weight per unit area) of the steel sheet as a whole.

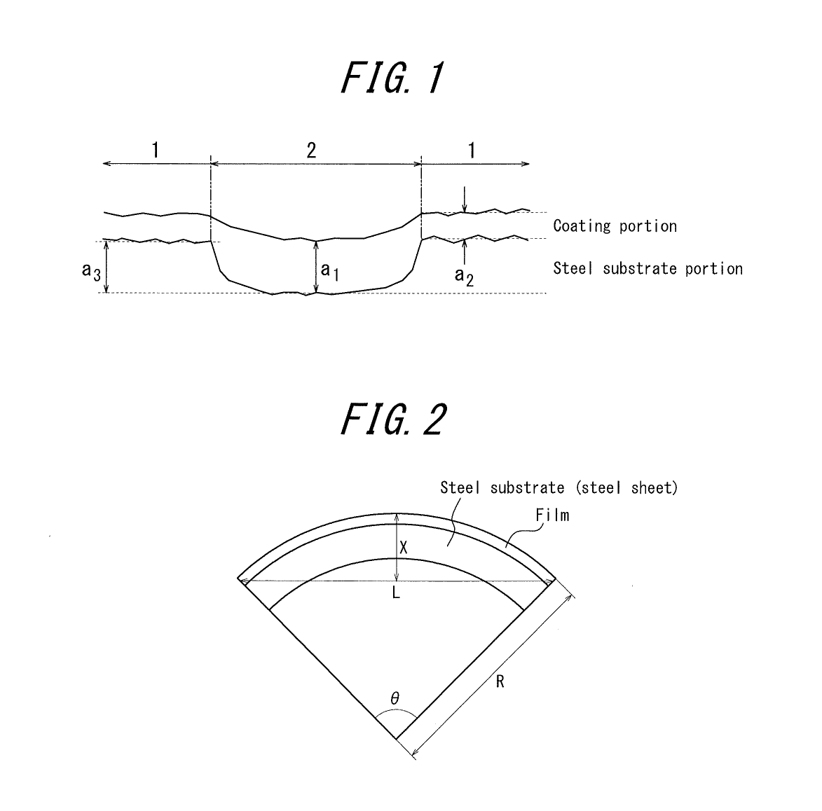

FIG. 1 is a schematic diagram illustrating a coating film thickness a₁ at the floor of a linear groove, a coating film thickness a₂ at portions other than the linear groove, and a linear groove depth a₃. In FIG. 1, reference numeral 1 is the portions other than the linear groove and reference numeral 2 is the linear groove. In addition, the lower ends of a₁ and a₂ as well as the upper and lower ends of a₃ represent the respective interfaces between the insulating coating and the forsterite film. We found that it is advantageous to control the coating film thickness a₁, coating film thickness a₂ and linear groove depth a₃ illustrated in FIG. 1 in an appropriate manner.

That is, the coating film thickness a₂ needs to satisfy Formula (1) shown below. This is because if the coating film thickness a₂ is below 0.3 μm, the insulating coating becomes so thin that the interlaminar resistance and corrosion resistance deteriorate. Alternatively, if a₂ is above 3.5 μm, the assembled actual transformer has a larger stacking factor.

0.3 μm≦a₂≦3.5 μm (1)

Then, as an important point, the coating film thicknesses a₁ and a₂ as well as the linear groove depth a₃ need to satisfy Formula (2):

a₂+a₃−a₁≦15(μm) (2).

This is because as the value of the left-hand side of the Formula (2) becomes smaller, the entire steel sheet involves less surface asperities and assumes a flatter shape, which avoids interruption of handling of the steel sheet and thus improves working efficiency without a problem that the magnetic properties of the steel sheet under strain deteriorate due to local stress. The linear groove depth a₃ represents a depth from the surface of the steel sheet, including the thickness of the forsterite film as mentioned above. It is also preferred that the lower limit of the Formula (2) is 3 (μm) and the linear groove depth a₃ is about 10 μm to 50 μm.

To reduce surface asperities, i.e., to lower the value of the left-hand side of the Formula (2), it is necessary to increase the film thickness a₁ at the floors of the grooves. To this end, for example, it is preferable to reduce the viscosity of the coating liquid and use hard rolls as coater rolls.

It is also preferred that tension generated by the coating film of the insulating coating is 8 MPa or less. This is because we locally increase tension because the groove portions have an increased film thickness of the coating. This results in a non-uniform stress distribution in the surface of the steel sheet. Hence, the insulating coating film becomes susceptible to exfoliation. It is preferable to reduce the coating tension to avoid this situation. Additionally, without any particular limitation, the lower limit of the tension generated by the coating film is about 4 MPa in view of improving iron loss properties by the tension effect.

Preferably, the above-described coating film is formed by using, for example, a phosphate-silica-based coating treatment liquid. At this moment, tension may be controlled by increasing the proportion of phosphate, using such phosphate that contributes to a higher thermal expansion coefficient (such as calcium phosphate or strontium phosphate) and so on. Application of this low-tension coating reduces the degree of variation in tension due to a difference in film thickness between the linear groove and the portions other than the linear groove, which makes the coating less prone to exfoliation. As used herein, the portions other than the linear groove 1 represents a portion excluding the portion of the linear groove 2 as illustrated in FIG. 1.

Additionally, the tension of the steel sheet generated by the insulating coating is measured and calculated as follows.

First, each steel sheet was immersed in an alkaline aqueous solution with tape applied to the measurement surface to exfoliate the insulating coating on the non-measurement surface. Then, as illustrated in FIG. 2, L and X are measured as warpage conditions of the steel sheet to determine L_{M} and X_{M}.

Then, the following Formulas (3) and (4) are used:

L=2R sin(θ/2) (3), and

X=R{1−cos(θ/2)} (4).

Then, the radius of curvature R is given by Formula (5):

R=(L²+4X²)/8X (5).

In Formula (5), substituting L=L_{M} and X=X_{M} yields the radius of curvature R. Further, a tensile stress a on the surface of the steel substrate may be calculated by substituting the radius of curvature R in Formula (6):

σ=E·ε=E·(d/2R) (6)
where
E: Young's modulus (E100=1.4×10⁵ MPa);
ε: interface strain of steel substrate (at sheet thickness center, ε=0); and
d: sheet thickness.

A slab for a grain oriented electrical steel sheet may have any chemical composition that causes secondary recrystallization having a great magnetic domain refining effect. As secondary recrystallized grains have a smaller deviation angle from Goss orientation, a greater effect of reducing iron loss can be achieved by magnetic domain refinement. Therefore, the deviation angle from Goss orientation is preferably 5.5° or less.

As used herein, the deviation angle from Goss orientation is the square root of (α²+β²), where α represents an α angle (a deviation angle from the (110)[001] ideal orientation around the axis in normal direction (ND) of the orientation of secondary recrystallized grains); and β represents a β angle (a deviation angle from the (110)[001] ideal orientation around the axis in transverse direction (TD) of the orientation of secondary recrystallized grains). The deviation angle from Goss orientation was measured by performing orientation measurement on a sample of 280 mm×30 mm at pitches of 5 mm. In this case, averages of the absolute values of α angle and β angle were determined and considered as the values of the above-described α and β, while ignoring any abnormal values obtained at the time of measuring grain boundary and so on. Accordingly, the values of α and β each represent an average per area, not an average per crystal grain.

In addition, regarding the compositions and manufacturing methods described below, numerical range limitations and selective elements/steps are merely illustrative of representative methods of manufacturing a grain oriented electrical steel sheet. Hence, our steel sheets and methods are not limited to the disclosed arrangements.

If an inhibitor, e.g., an AlN-based inhibitor is used, Al and N may be contained in an appropriate amount, respectively, while if a MnS/MnSe-based inhibitor is used, Mn and Se and/or S may be contained in an appropriate amount, respectively. Of course, these inhibitors may also be used in combination. In this case, preferred contents of Al, N, S and Se are: Al: 0.01 mass % to 0.065 mass %; N: 0.005 mass % to 0.012 mass %; S: 0.005 mass % to 0.03 mass %; and Se: 0.005 mass % to 0.03 mass %, respectively.

Further, we provide a grain oriented electrical steel sheet having limited contents of Al, N, S and Se without using an inhibitor. In this case, the contents of Al, N, S and Se are preferably limited to Al: 100 mass ppm or less, N: 50 mass ppm or less, S: 50 mass ppm or less, and Se: 50 mass ppm or less, respectively.

The basic elements and other optionally added elements of the slab for a grain oriented electrical steel sheet will be specifically described below.

C≦0.15 mass %

Carbon (C) is added to improve the texture of a hot-rolled sheet. However, C content in steel exceeding 0.15 mass % makes it more difficult to reduce the C content to 50 mass ppm or less where magnetic aging will not occur during the manufacturing process. Thus, the C content is preferably 0.15 mass % or less. Besides, it is not necessary to set up a particular lower limit to the C content because secondary recrystallization is enabled by a material not containing C. 2.0 mass %≦Si≦8.0 mass %

Silicon (Si) is an element effective in terms of enhancing electrical resistance of steel and improving iron loss properties thereof. However, Si content in steel below 2.0 mass % cannot provide a sufficient effect of improving iron loss. On the other hand, Si content in steel above 8.0 mass % significantly deteriorates formability and also decreases flux density of the steel. Accordingly, the Si content is preferably 2.0 mass % to 8.0 mass %.

0.005 mass %≦Mn≦1.0 mass %

Manganese (Mn) is an element necessary in terms of achieving better hot workability of steel. However, Mn content in steel below 0.005 mass % cannot provide such a good effect of manganese. On the other hand, Mn content in steel above 1.0 mass % deteriorates magnetic flux of a product steel sheet. Accordingly, the Mn content is preferably 0.005 mass % to 1.0 mass %.

Further, in addition to the above elements, the slab may also contain the following elements as elements that improve magnetic properties as deemed appropriate:
at least one element selected from Ni: 0.03 mass % to 1.50 mass %, Sn: 0.01 mass % to 1.50 mass %, Sb: 0.005 mass % to 1.50 mass %, Cu: 0.03 mass % to 3.0 mass %, P: 0.03 mass % to 0.50 mass %, Mo: 0.005 mass % to 0.10 mass %, and Cr: 0.03 mass % to 1.50 mass %.

Nickel (Ni) is an element useful to improve the microstructure of a hot rolled steel sheet for better magnetic properties thereof. However, Ni content in steel below 0.03 mass % is less effective in improving magnetic properties, while Ni content in steel above 1.5 mass % makes secondary recrystallization of the steel unstable, thereby deteriorating magnetic properties thereof. Thus, Ni content is preferably 0.03 mass % to 1.5 mass %.

In addition, tin (Sn), antimony (Sb), copper (Cu), phosphorus (P), molybdenum (Mo) and chromium (Cr) are useful elements in terms of improving magnetic properties of steel. However, each of these elements becomes less effective in improving magnetic properties of the steel when contained in steel in an amount less than the aforementioned lower limit, or alternatively, when contained in steel in an amount exceeding the aforementioned upper limit, inhibits the growth of secondary recrystallized grains of the steel. Thus, each of these elements is preferably contained within the respective ranges thereof specified above.

The balance other than the above-described elements is Fe and incidental impurities that are incorporated during the manufacturing process.

Then, the slab having the above-described chemical composition is subjected to heating before hot rolling in a conventional manner. However, the slab may also be subjected to hot rolling directly after casting without being subjected to heating. In the case of a thin slab or thinner cast steel, it may be subjected to hot rolling or directly proceed to the subsequent step, omitting hot rolling.

Further, the hot rolled sheet is optionally subjected to hot band annealing. At this moment, to obtain a highly-developed Goss texture in a product sheet, a hot band annealing temperature is preferably 800° C. to 1200° C. If a hot band annealing temperature is lower than 800° C., there remains a band texture resulting from hot rolling which makes it difficult to obtain a primary recrystallization texture of uniformly-sized grains and impedes the growth of secondary recrystallization. On the other hand, if a hot band annealing temperature exceeds 1200° C., the grain size after the hot band annealing coarsens too much, which makes it extremely difficult to obtain a primary recrystallization texture of uniformly-sized grains.

After the hot band annealing, the sheet is subjected to cold rolling once, or twice or more with intermediate annealing performed therebetween, followed by primary recrystallization annealing and application of an annealing separator to the sheet. The steel sheet may also be subjected to nitridation or the like for the purpose of strengthening any inhibitor, either during the primary recrystallization annealing, or after the primary recrystallization annealing and before the initiation of the secondary recrystallization. After application of the annealing separator prior to secondary recrystallization annealing, the sheet is subjected to final annealing for purposes of secondary recrystallization and formation of a forsterite film.

As described below, formation of grooves may be performed at any time as long as it is after final cold rolling such as before or after the primary recrystallization annealing, before or after the secondary recrystallization annealing, before or after the flattening annealing, and so on. However, if grooves are formed after tension coating, it can require extra steps to remove some portions of the film to make room for grooves to be formed, form the grooves in the manner described below, and re-form those portions of the film. Accordingly, formation of grooves is preferably performed after the final cold rolling and before forming tension coating.

After final annealing, it is effective to subject the sheet to flattening annealing to correct the shape thereof. Tension coating is applied to a surface of the steel sheet before or after flattening annealing. It is also possible to apply a tension coating treatment liquid prior to flattening annealing for the purpose of combining flattening annealing with baking of the coating.

When applying tension coating to the steel sheet, it is important to appropriately control, as mentioned earlier, the coating film thickness a₁ (μm) at the floors of the linear grooves, the coating film thickness a₂ (μm) at the portions other than the linear grooves and, furthermore, the groove depth a₃ (μm).

As used herein, the term “tension coating” indicates insulating coating that applies tension to the steel sheet for the purpose of reducing iron loss. It should be noted that any tension coating is advantageously applicable that contains silica and phosphate as its principal components. In addition to this, other coating is also applicable, such as coating using borate and alumina sol or coating using composite hydroxides.

Grooves are formed by different methods including conventionally well-known methods of forming grooves, e.g., a local etching method, a scribing method using cutters or the like, a rolling method using rolls with projections and so on. The most preferable method is a method that involves adhering by printing or the like, etching resist to a steel sheet after being subjected to the final cold rolling, and then forming grooves on a non-adhesion region of the steel sheet through some process such as electrolytic etching. This is because in a method where grooves are formed in a mechanical manner, the resulting grooves are blunt-edged due to extremely severe abrasion of the cutters and rolls. Further, there is another problem associated with replacement of the cutters and rolls that leads to lower productivity.

It is preferable that grooves are formed on a surface of the steel sheet at intervals of about 1.5 mm to 10.0 mm, and at an angle in the range of about ±30° relative to a direction perpendicular to the rolling direction so that each groove has a width of about 50 μm to 300 μm and a depth of about 10 μm to 50 μm. As used herein, “linear” is intended to encompass solid line as well as dotted line, dashed line and so on.

Except the above-mentioned steps and manufacturing conditions, it is possible to use, as appropriate, a conventionally well-known method of manufacturing a grain oriented electrical steel sheet where magnetic domain refining treatment is applied by forming grooves.

### Example 1

Steel slabs were manufactured by continuous casting, each steel slab having a composition containing, in mass %: C: 0.05%; Si: 3.2%; Mn: 0.06%; Se: 0.02%; Sb: 0.02%; and the balance being Fe and incidental impurities. Then, each of these steel slabs was heated to 1400° C., subjected to subsequent hot rolling to be finished to a hot-rolled sheet having a sheet thickness of 2.6 mm, and then subjected to hot band annealing at 1000° C. Each steel sheet was then subjected to cold rolling twice, with intermediate annealing performed therebetween at 1000° C., to be finished to a cold-rolled sheet having a final sheet thickness of 0.30 mm.

Thereafter, each steel sheet was applied with etching resist by gravure offset printing and subjected to electrolytic etching and resist stripping in an alkaline solution, whereby linear grooves, each having a width of 150 μm and a depth of 20 μm, were formed at intervals of 3 mm at an angle of 10° relative to a direction perpendicular to the rolling direction. Then, each steel sheet was subjected to decarburizing annealing at 825° C., applied with an annealing separator composed mainly of MgO, and subjected to subsequent final annealing for the purposes of secondary recrystallization and purification under the conditions of 1200° C. and 10 hours.

Then, each steel sheet was applied with a tension coating treatment solution and subjected to flattening annealing at 830° C. during which the tension coating was also baked simultaneously, to thereby provide a product steel sheet. In this case, as shown in Table 1, coating was applied, dried and baked under different film thickness conditions while changing the coater roll hardness, coating liquid viscosity and coating liquid composition. These products were used to manufacture oil-immersed transformers at 1000 kVA, for which iron loss was measured. In addition, each product thus obtained was evaluated for magnetic property, coating tension, stacking factor, rust ratio, and interlaminar resistance.

The magnetic property, stacking factor and interlaminar resistance of each product were measured according to the method specified in JIS C2550, while the rust ratio was measured by visually determining the rust ratio of the product after holding the product in the atmosphere with a temperature of 50° C. and a dew point of 50° C. for 50 hours. In addition, the coating tension was measured in accordance with the above-mentioned method.

The above-described measurement results are shown in Table 2.

TABLE 1

| | Coater Roll | Coating | Coating |
|---|---|---|---|
| Condition | Hardness | Liquid | Liquid |
| No. | JIS-A* | Viscosity (cP) | Composition |
| 1 | 70 | 1.2 | A |
| 2 | 70 | 1.2 | A |
| 3 | 70 | 1.2 | B |
| 4 | 70 | 1.2 | B |
| 5 | 70 | 1.2 | B |
| 6 | 70 | 1.2 | B |
| 7 | 70 | 1.2 | B |
| 8 | 70 | 1.4 | B |
| 9 | 70 | 1.3 | B |
| 10 | 70 | 1.2 | B |
| 11 | 70 | 1.1 | B |
| 12 | 50 | 1.2 | B |
| 13 | 50 | 1.1 | B |
| 14 | 70 | 1.2 | C |
| 15 | 70 | 1.2 | C |

*JIS K6301-1975
A: Sr Phosphate: 40 mass pts., Colloidal SiO₂: 30 mass pts., Anhydrous Chromate: 5 mass pts., Silica Flour: 0.5 mass pts.
B: Al Phosphate: 40 mass pts., Colloidal SiO₂: 20 mass pts., Anhydrous Chromate: 5 mass pts., Silica Flour: 0.5 mass pts.
C: Mg Phosphate: 20 mass pts., Colloidal SiO₂: 30 mass pts., Anhydrous Chromate: 5 mass pts., Silica Flour: 0.5 mass pts.

TABLE 2

| | | Film | | | | | | | | | |
|---|---|---|---|---|---|---|---|---|---|---|---|
| | Film | Thickness | | | | | | | | Transformer | |
| | Thickness | at Portions | | | | | | Inter- | Cut Sheet | Iron | |
| | at Floors of | other than | Groove | | Coating | Stacking | Rust | laminar | Iron Loss | Loss | |
| Experiment | Grooves a₁ | Grooves a₂ | Depth a₃ | | Tension | Factor | Ratio | Resistance | W_{17/50} | W_{17/50} | |
| No. | (μm) | (μm) | (μm) | a₂ + a₃ − a₁ | (MPa) | (%) | (%) | (Ω · cm²) | (W/kg) | (W/kg) | Remarks |
| 1 | 10.2 | 0.2 | 20 | 10.0 | 6.4 | 97.9 | 20 | 20 | 0.97 | 1.27 | Comparative |
| | | | | | | | | | | | Example |
| 2 | 9.5 | 0.3 | 20 | 10.8 | 6.5 | 97.9 | 5 | ≧200 | 0.96 | 1.14 | Example |
| 3 | 10.5 | 1.1 | 20 | 10.6 | 7.6 | 97.5 | ≦5 | ≧200 | 0.95 | 1.12 | Example |
| 4 | 11.9 | 2.1 | 20 | 10.2 | 7.1 | 97.5 | ≦5 | ≧200 | 0.95 | 1.10 | Example |
| 5 | 12.4 | 2.8 | 20 | 10.4 | 7.2 | 97.4 | ≦5 | ≧200 | 0.95 | 1.11 | Example |
| 6 | 13.6 | 3.5 | 20 | 9.9 | 7.5 | 97.3 | ≦5 | ≧200 | 0.95 | 1.13 | Example |
| 7 | 14.5 | 4.1 | 20 | 9.6 | 7.4 | 96.9 | 15 | 50 | 0.95 | 1.28 | Comparative |
| | | | | | | | | | | | Example |
| 8 | 2.4 | 2.2 | 20 | 19.8 | 7.3 | 97.4 | 20 | 20 | 0.95 | 1.26 | Comparative |
| | | | | | | | | | | | Example |
| 9 | 4.2 | 2.1 | 20 | 17.9 | 7.2 | 97.5 | 20 | 20 | 0.95 | 1.25 | Comparative |
| | | | | | | | | | | | Example |
| 10 | 7.4 | 2.3 | 20 | 14.9 | 7.3 | 97.6 | 5 | ≧200 | 0.95 | 1.15 | Example |
| 11 | 8.6 | 1.9 | 20 | 13.3 | 7.4 | 97.6 | ≦5 | ≧200 | 0.95 | 1.14 | Example |
| 12 | 12.1 | 2.3 | 20 | 10.2 | 7.5 | 97.6 | ≦5 | ≧200 | 0.95 | 1.12 | Example |
| 13 | 20.0 | 2.1 | 20 | 2.1 | 7.1 | 97.5 | ≦5 | ≧200 | 0.95 | 1.11 | Example |
| 14 | 13.3 | 2.2 | 20 | 8.9 | 10.5 | 97.4 | 5 | 100 | 0.95 | 1.20 | Example |
| 15 | 13.3 | 3.2 | 20 | 9.9 | 12.6 | 97.5 | 10 | 80 | 0.95 | 1.21 | Example |

* - Magnetic Property, Stacking Factor, Interlaminar Resistance: measured under JIS C2550.
Rust Ratio: visually determined by measuring the rust ratio of each product after being held in atmosphere with temperature of 50° C., dew point of 50° C. for 50 hours.

As shown in Table 2, all of our grain oriented electrical steel sheets of Experiment Nos. 2 to 6 and 10 to 15 that satisfy the above Formulas (1) and (2) exhibited extremely good iron loss properties when assembled as transformers.

However, the grain oriented electrical steel sheets of Experiment Nos. 1 and 7 that do not satisfy the Formula (1), as well as the grain oriented electrical steel sheets of Experiment Nos. 8 and 9 that do not satisfy the Formula (2) showed inferior iron loss properties when assembled as transformers.

1. A grain oriented electrical steel sheet comprising: linear grooves provided on a surface of the steel sheet; and an insulating coating applied to the surface, wherein a film thickness a₁ (μm) of the insulating coating at floors of the linear grooves, a film thickness a₂ (μm) of the insulating coating on the surface of the steel sheet at portions other than the linear grooves, and a depth a₃ (μm) of the linear grooves satisfy formulas (1) and (2):
0.3 μm≦a₂≦3.5 μm (1), and
a₂+a₃−a₁≦15 μm (2).

2. The grain oriented electrical steel sheet according to claim 1, wherein tension applied to the steel sheet by the insulating coating is 8 MPa or less.

3. The grain oriented electrical steel sheet according to claim 1, wherein the insulating coating is formed with a phosphate-silica-based coating treatment liquid.

4. The grain oriented electrical steel sheet according to claim 2, wherein the insulating coating is formed with a phosphate-silica-based coating treatment liquid.
